(19) United States
(12) Patent Application Publication
(10) Pub. No.: US 2025/0311708 A1
(43) Pub. Date: Oct. 9, 2025

(54) ELECTRIC FISHING LINE REEL

(71) Applicant: Weihai Langbao Fishing Tackle CO., LTD, Weihai (CN)

(72) Inventor: WEI WANG, Weihai (CN)

(21) Appl. No.: 18/667,039

(22) Filed: May 17, 2024

(30) Foreign Application Priority Data
Apr. 9, 2024 (CN) 202420724760.6

(51) Int. Cl. A01K 89/033

(52) U.S. Cl. CPC A01K 89/05

(57) ABSTRACT

Provided is an electric fishing line reel, including a bracket, end covers, and a line cup shaft. A clutch mechanism that enables a line cup to be switched between a combined state and a clutch state is arranged on one side of the line cup shaft. The clutch mechanism includes a clutch gear that is separated from/combined with the line cup shaft, a clutch that matches the clutch gear and drives the clutch gear to move in an axial direction, and a clutch cam that drives the clutch to move in the axial direction. Bearings are added to both ends of the clutch gear for supporting, which ensures the stability of a position of the clutch gear, and reduces a friction force generated when the clutch gear moves in the axial direction.

### CROSS-REFERENCE TO RELATED APPLICATIONS

This application claims priority to Chinese Patent Application No. 202420724760.6, filed on Apr. 9, 2024, which is hereby incorporated by reference in its entirety.

### TECHNICAL FIELD

This present disclosure relates to the field of fishing gear, and in particular, to an electric fishing line reel.

### BACKGROUND

Existing electric fishing line reel on the market has fishing line retracting and releasing functions. When a fishing line is released, a line release switch is turned on, a clutch gear is separated from a line cup, and a tension spring pushes a clutch claw to a position of a check wheel. At this moment, the line cup is in a free rotation state, and the line cup starts to release the fishing line under the action of a lead weight. When the fishing line is retracted, a rocking arm is rotated, the check wheel pushes the clutch claw to move, the line release switch is automatically turned off, the clutch gear is combined with the line cup, and the fishing line pulls up the lead weight from water with the rotation of the line cup. In line retracting and releasing processes of an electric wheel of an existing structure, there are often problems that the clutch gear cannot to be combined with the line cup quickly, there is noise and the like, the clutch claw cannot move in place, the line release switch cannot be turned off automatically, and there is friction between the line release switch and a bracket to lead to the damage of a paint layer of the bracket.

### SUMMARY

In view of disadvantages in a conventional art, to solve the problems that a clutch gear cannot be quickly combined with a line cup in a retracting state and a releasing state of an electric reel, there is noise, a clutch claw cannot move in place, a line release switch cannot be turned off automatically, and there is friction between the line release switch and a bracket to damage a paint layer of the bracket, this present disclosure provides an electric fishing line reel that provides a better user experience.

To achieve a purpose described above, this application adopts a technical solution that:

An electric fishing line reel includes a bracket, end covers arranged at both ends of the bracket, and a line cup shaft that is configured to mount a line cup and drives the line cup to move. A clutch mechanism that enables the line cup to be switched between a combined state and a clutch state is arranged on one side of the line cup shaft. The clutch mechanism includes a clutch gear that is separated from/combined with the line cup shaft, a clutch that matches the clutch gear and drives the clutch gear to move in an axial direction, and a clutch cam that drives the clutch to move in the axial direction. A rectangular flat column with inclined planes on diagonal sides is at an end, combined with the clutch gear, of the line cup shaft. A rectangular groove A is at an end, combined with the line cup shaft, of the clutch gear. The rectangular flat column matches the rectangular groove A. Clutch gear bearings that support the clutch gear are arranged at both ends of the clutch gear.

Line cup shaft bearings that support the line cup shaft are arranged at both ends of the line cup shaft. A gear mounting disc is arranged on a side of the end, combined with the clutch gear, of the line cup shaft. Three line cup driving gears are uniformly distributed on the gear mounting disc.

The clutch cam is connected to the line release switch through a connecting rod. The clutch cam is mounted on the bracket. Anti-friction plates with smooth surfaces are arranged between the line release switch and the bracket.

A clutch is arranged on an upper surface of the clutch cam. Clutch sleeves are arranged at both ends of the clutch. A clutch pressure spring is assembled above the clutch sleeve. Both ends of the clutch pressure spring are respectively in contact with the clutch sleeve and the end cover. The clutch pressure spring has a compression amount.

A groove B is formed in a center of the clutch. The clutch gear is clamped in the groove B.

More preferably, the clutch cam is pressed by using a pressing plate. The pressing plate is fixed to the bracket. A clutch claw is also mounted on the bracket. A hanging hook A is arranged on the clutch claw. A hanging hook B is arranged on the pressing plate. Two ends of a tension spring are respectively connected to the hanging hook A and the hanging hook B. The clutch claw has a trajectory surface, a reset surface B, and a pushing surface A. The reset surface of the clutch claw matches a reset surface A of the clutch cam. The pushing surface A of the clutch claw matches a pushing surface B of a check wheel. The trajectory surface of the clutch claw matches a clutch claw column.

This present disclosure has the beneficial effects that: (1) bearings are added to both ends of a clutch gear for supporting, which ensures the stability of a position of the clutch gear, reduces a friction force generated when the clutch gear moves in a axial direction, a line cup shaft adopts a rectangular flat column with inclined planes on diagonal sides, and the clutch gear adopts a rectangular groove A, which can achieve quick combination of the clutch gear and the line cup shaft, and reduce the damage to the clutch gear and noise during operating; (2) two anti-friction plates with smooth surfaces are added between a line release switch and a bracket, and the line release switch rubs against the two anti-friction plates during moving, which ensures smooth movement of the line release switch, and protects a paint surface of the bracket; and (3) a clutch claw is pulled to a position of a check wheel by using a tension spring, which ensures that the clutch claw moves in place since the tension spring does not have an issue of angle, and the check wheel can push the clutch claw when the line release switch is reset.

### BRIEF DESCRIPTION OF DRAWINGS

To describe embodiments of this application or technical solutions in a conventional art more clearly, drawings required to be used in the description of the embodiments or the conventional art will be briefly described below. It is apparent that the drawings in the following description are only some embodiments of this application, and other drawings may be obtained from those skilled in the art according to these drawings without any creative work.

FIG. 1 is a schematic diagram of a clutch structure of an electric wheel.

FIG. 2 is a schematic diagram of an off state of a line release switch.

FIG. 3 is a schematic diagram of an on state of a line release switch.

FIG. 4 is a schematic diagram of assembly of an anti-friction plate.

FIG. 5 is a schematic structural diagram of a clutch gear.

FIG. 6 is a schematic structural diagram of a reel wheel shaft.

FIG. 7 is a schematic structural diagram of a clutch gear.

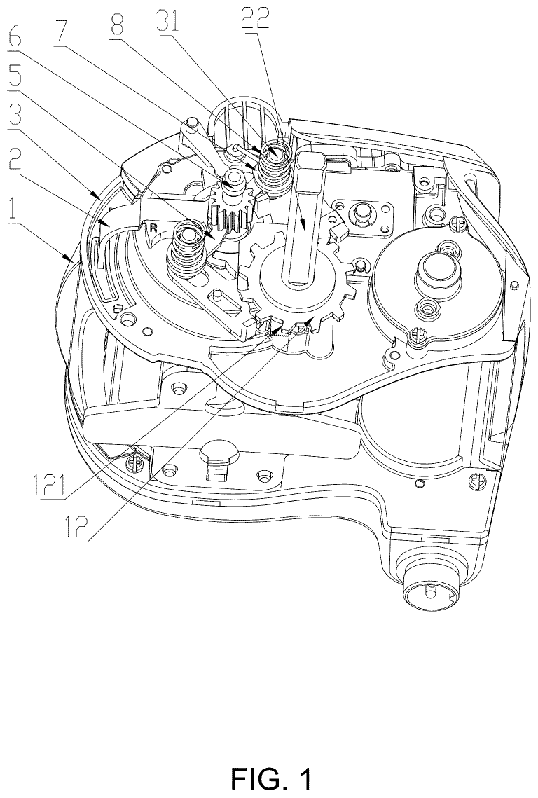

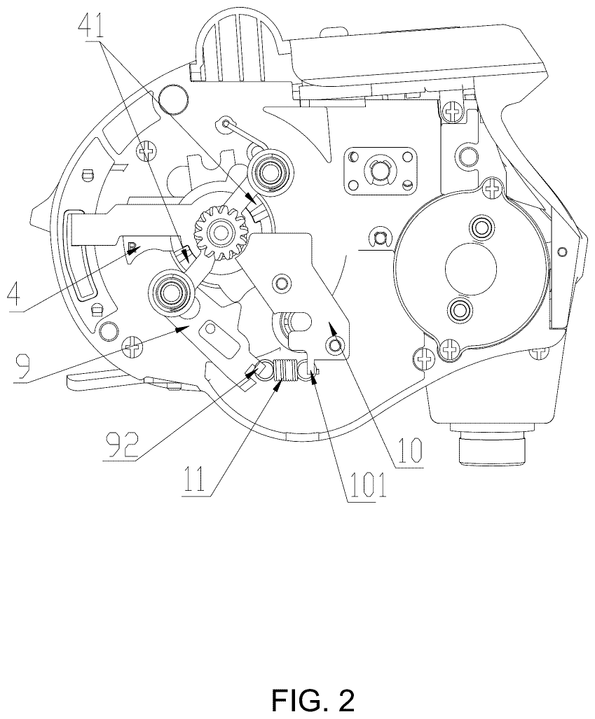

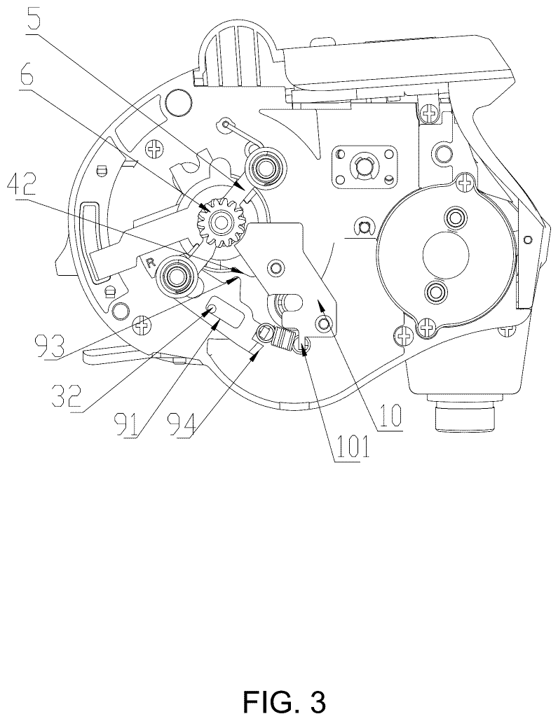

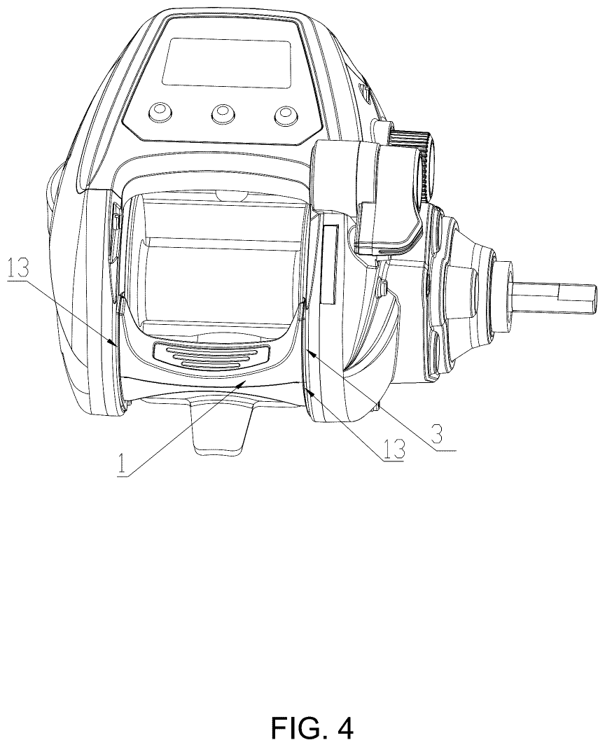

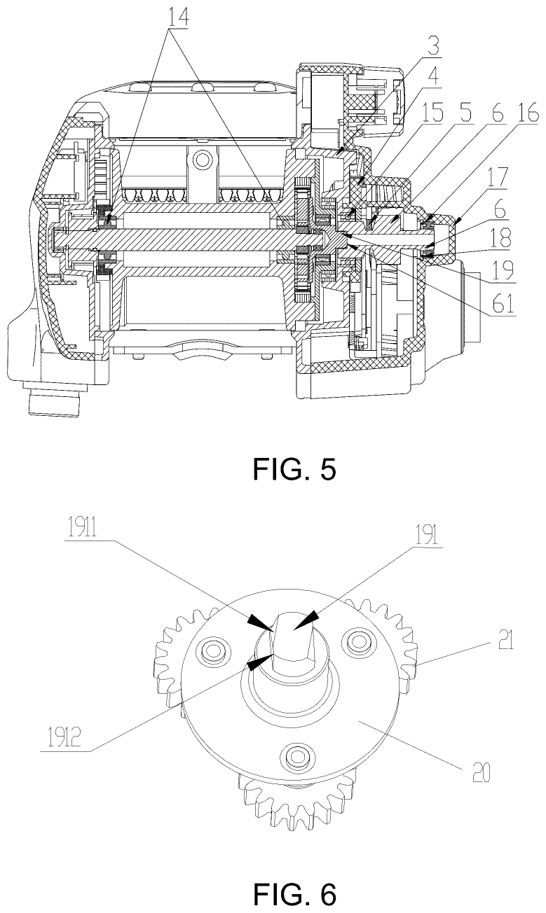

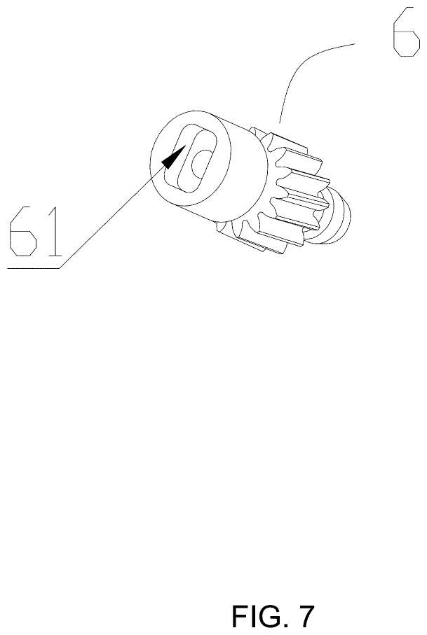

In the drawings: 1—line release switch, 2—connecting rod, 3—bracket, 31—positioning column, 32—clutch claw column, 4—clutch cam, 41—cam surface, 42—reset surface A, 5—clutch, 51—groove B, 6—clutch gear, 61—groove A, 7—clutch sleeve, 8—clutch pressure spring, 9—clutch claw, 91—trajectory surface, 92—hanging hook A, 93—reset surface B, 94—pushing surface A, 10—pressing plate, 101—hanging hook B, 11—tension spring, 12—check wheel, 121—pushing surface B, 13—anti-friction plate, 14—line cup shaft bearing, 15—clutch gear bearing A, 16—clutch gear bearing B, 17—end cover, 18—catch spring, 19—line cup shaft, 191—rectangular flat column, 1911—entrance surface, 1912—driving surface, 20—gear mounting disc, 21—line cup driving gear, and 22—main gear shaft.

### DESCRIPTION OF EMBODIMENTS

To make the objectives, technical solutions, and advantages of embodiments of this application clearer, the following clearly and completely describes the technical solutions in the embodiments of the this application with reference to accompanying drawings in the embodiments of the this application. Apparently, the described embodiments are part rather than all of the embodiments of the this application. Typically, components of the embodiments of this application described and shown in the accompanying drawings herein may be arranged and designed in a variety of different configurations.

In the descriptions of this application, it is also to be noted that, unless otherwise specified and defined explicitly, terms “arranged”, “mounted”, “interconnected”, and “connected” are to be interpreted broadly, for example, may be fixedly connected, detachably connected, or integrally connected, may be mechanically connected or electrically connected, may be directly connected, or indirectly connected through an intermediate medium, or internally communicated between two elements. For those of ordinary skill in the art, specific meanings of these terms in this application may be understood according to a specific condition.

An electric fishing line reel includes a bracket 3, end covers 17 arranged at both ends of the bracket 3, and a line cup shaft 19 that is configured to mount a line cup and drives the line cup to move. A clutch mechanism that enables the line cup to be switched between a combined state and a clutch state is arranged on one side of the line cup shaft 19. The clutch mechanism includes a clutch gear 6 that is separated from/combined with the line cup shaft 19, a clutch 5 that matches the clutch gear 6 and drives the clutch gear 6 to move in an axial direction, and a clutch cam 4 that drives the clutch 5 to move in the axial direction. A rectangular flat column 191 with inclined planes on diagonal sides is at an end, combined with the clutch gear 6, of the line cup shaft 19. A rectangular groove A 61 is at an end, combined with the line cup shaft 19, of the clutch gear 6. The rectangular flat column 191 matches the rectangular groove A 61. Clutch gear bearings that support the clutch gear 6 are arranged at both ends of the clutch gear 6. The rectangular flat column 191 with inclined planes on diagonal sides of the line cup shaft 19 has an entrance surface 1911 and a driving surface 1912. When the clutch gear 6 is combined with the line cup shaft 19, the groove A 61 in the clutch gear 6 enters from the entrance surface 1911. When the clutch gear 6 drives the line cup to rotate, the driving surface 1912 drives the line cup shaft 19 to rotate. Clutch gear bearings are arranged at both ends of the clutch gear 6. A clutch gear bearing A 15 is mounted in the bracket 3, and is pressed by a connecting rod 2. Clutch gear bearings B 16 are mounted in the end covers 17, and are fixed by catch springs 18, which ensures the accuracy of a position when the clutch gear 6 moves.

Line cup shaft bearings 14 that support the line cup shaft 19 are arranged at both ends of the line cup shaft 19. A gear mounting disc 20 is arranged on a side of the end, combined with the clutch gear 6, of the line cup shaft 19. Three line cup driving gears 21 are uniformly distributed on the gear mounting disc 20. The three line cup driving gears 21 support stably.

The clutch cam 4 is connected to the line release switch 1 through the connecting rod 2. The clutch cam 4 is mounted on the bracket 3. Anti-friction plates 13 with smooth surfaces are arranged between the line release switch 1 and the bracket 3. The line release switch 1 moves between two sides of the bracket 3. The anti-friction plates 13 are added to both sides of the bracket 3 to prevent friction between the line release switch 1 and the bracket 3, maintain smooth movement of the line release switch, and prevent a paint surface of the bracket from being damaged.

A clutch 5 is arranged on an upper surface of the clutch cam 4. Clutch sleeves 7 are arranged at both ends of the clutch 5. The clutch sleeves 7 are in limit fit with positioning columns 31 on the bracket 3. A clutch pressure spring 8 is assembled above the clutch sleeve 7. Both ends of the clutch pressure spring 8 are respectively in contact with the clutch sleeve 7 and the end cover 17. The clutch pressure spring 8 has a compression amount.

A groove B 51 is formed in a center of the clutch 5. The clutch gear 6 is clamped in the groove B 51. The clutch cam 4 is pressed by using a pressing plate 10. The pressing plate 10 is fixed to the bracket 3. A clutch claw 9 is also mounted on the bracket 3. A hanging hook A 92 is arranged on the clutch claw 9. A hanging hook B 101 is arranged on the pressing plate 10. Two ends of a tension spring 11 are respectively connected to the hanging hook A 92 and the hanging hook B 101. The clutch claw 9 has a trajectory surface 91, a reset surface B 93, and a pushing surface A 94. The reset surface B 93 of the clutch claw 9 matches a reset surface A 42 of the clutch cam 4. The pushing surface A 94 of the clutch claw 9 matches a pushing surface B 121 of a check wheel 12 mounted on a main gear shaft 22. The trajectory surface 91 of the clutch claw 9 matches a clutch claw column 32 on the bracket. According to the electric fishing line reel of this present disclosure, when the line release switch 1 is pressed down, the clutch cam 4 is driven to move together, the reset surface B 93 of the clutch claw 9 is separated from the reset surface A 42 of the clutch cam 4, the clutch claw 9 moves under the action of the tension spring 11, the clutch claw column 32 is in contact with the trajectory surface 91, and the pushing surface A 94 of clutch claw 9 is located among a plurality of pushing surfaces B 121 of the check wheel 12. The cam surface 41 of the clutch cam 4 pushes the clutch 5 and drives the clutch gear 6 to move in axial direction of the positioning column 31. The compression amount of the clutch pressure spring 8 is increased, and the clutch gear 6 is separated from the line cup shaft 19. At this moment, the line cup is in a line releasing state.

When the line release switch 1 is reset, the pushing surface B 121 of the check wheel 12 pushes the pushing surface A of the clutch claw 9 to move. The trajectory surface 91 of the clutch claw 9 moves along the clutch claw column 32. The clutch claw 9 pushes the clutch cam 4 to a position where the line release switch 1 is turned off. Under the action of the clutch pressure spring 8, the clutch 5 pushes the clutch gear 6 to a position where the clutch gear 6 is in combination with the line cup shaft 19. At this moment, the line cup is in a line retracting state.

The above is only a preferred embodiment of this application, and is not intended to limit this application. For those skilled in the art, this application may have various changes and variations. Any modifications, equivalent replacements, improvements and the like made within the spirit and principle of this application all fall within the scope of protection of this application.

What is claimed is:

1. An electric fishing line reel, comprising a bracket (3), end covers (17) arranged at both ends of the bracket (3), and a line cup shaft (19) that is configured to mount a line cup and drives the line cup to move, wherein a clutch mechanism that enables the line cup to be switched between a combined state and a clutch state is arranged on one side of the line cup shaft (19); the clutch mechanism comprises a clutch gear (6) that is separated from/combined with the line cup shaft (19), a clutch (5) that matches the clutch gear (6) and drives the clutch gear (6) to move in an axial direction, and a clutch cam (4) that drives the clutch (5) to move in the axial direction; a rectangular flat column (191) with inclined planes on diagonal sides is at an end, combined with the clutch gear (6), of the line cup shaft (19); a rectangular groove A (61) is at an end, combined with the line cup shaft (19), of the clutch gear (6); the rectangular flat column (191) matches the rectangular groove A (61); and clutch gear (6) bearings that support the clutch gear (6) are arranged at both ends of the clutch gear (6).

2. The electric fishing line reel according to claim 1, wherein line cup shaft bearings (14) that support the line cup shaft (19) are arranged at both ends of the line cup shaft (19); a gear mounting disc (20) is arranged on a side of the end, combined with the clutch gear (6), of the line cup shaft (19); and three line cup driving gears (21) are uniformly distributed on the gear mounting disc (20).

3. The electric fishing line reel according to claim 1, wherein the clutch cam (4) is connected to the line release switch (1) through a connecting rod (2); the clutch cam (4) is mounted on the bracket (3); and anti-friction plates (13) with smooth surfaces are arranged between the line release switch (1) and the bracket (3).

4. The electric fishing line reel according to claim 1, wherein a clutch (5) is arranged on an upper surface of the clutch cam (4); clutch sleeves (7) are arranged at both ends of the clutch (5); a clutch pressure spring (8) is assembled above the clutch sleeve (7); both ends of the clutch pressure spring (8) are respectively in contact with the clutch sleeve (7) and the end cover (17); and the clutch pressure spring (8) has a compression amount.

5. The electric fishing line reel according to claim 4, wherein a groove B (51) is formed in a center of the clutch (5); and the clutch gear (6) is clamped in the groove B (51).

6. The electric fishing line reel according to claim 1, wherein the clutch cam (4) is pressed by using a pressing plate (10); the pressing plate (10) is fixed to the bracket (3); a clutch claw (9) is also mounted on the bracket (3); a hanging hook A (92) is arranged on the clutch claw (9); a hanging hook B (101) is arranged on the pressing plate (10); two ends of a tension spring (11) are respectively connected to the hanging hook A (92) and the hanging hook B (101); the clutch claw (9) has a trajectory surface (91), a reset surface B (93), and a pushing surface A (94); the reset surface of the clutch claw (9) matches a reset surface A (42) of the clutch cam (4); the pushing surface A (94) of the clutch claw (9) matches a pushing surface B (121) of a check wheel (12); and the trajectory surface (91) of the clutch claw (9) matches a clutch claw column (32).
